(19) United States
(12) Patent Application Publication
(10) Pub. No.: US 2025/0263299 A1
(43) Pub. Date: Aug. 21, 2025

(54) Hybridized Body-Centered Tetragonal (BCT) Carbon

(71) Applicant: Amrita Vishwa Vidyapeetham, Tamil Nadu (IN)

(72) Inventors: Sreekala Chandrasekharannair Omanaamma, Alappuzha (IN); Jose Rajan, Triyandrum (IN); Devu Bindhu, Kollam (IN)

(73) Assignee: Amrita Vishwa Vidyapeetham, Tamil Nadu (IN)

(21) Appl. No.: 18/675,846

(22) Filed: May 28, 2024

(30) Foreign Application Priority Data
Feb. 19, 2024 (IN) 202441011550

(51) Int. Cl. C01B 32/05

(52) U.S. Cl. CPC C01B 32/05; C01P 2002/77; C01P 2004/30

(57) ABSTRACT

A process for synthesizing body-centered tetragonal carbon involves steps for securing a quantity of palm rachis material, thoroughly drying the rachis material, pre-carbonizing the dried rachis material, pulverizing the pre-carbonized and dried rachis material, and carbonizing the pulverized rachis material.

### CROSS REFERENCE TO RELATED APPLICATIONS

The present application claims priority to India patent application No. 202441011550 filed 19 Feb. 2024. All disclosure of the parent case is incorporated herein at least by reference.

### BACKGROUND OF THE INVENTION

### 1. Field of the Invention

The present invention is in the technical field of phases and synthesis of carbon materials and pertains more particularly to synthesis of a body-centered tetragonal carbon material from a specific precursor material.

### 2. Description of Related Art

Carbon is an extensively utilized material with distinctive physical and chemical properties. Various forms of carbon are useful for many applications due to relatively low density, strong mechanical strength, good thermal and electrical conductivity, high stability, and a capacity to exist in various forms. Carbon, with its unique ability to form allotropes like graphene, graphite, carbon nanotubes, fullerene, diamond and so forth, qualifies the various forms of carbon to be important in a pending technological scientific era. Due to a wide network of sp³, sp², and sp hybridization, these allotropes offer unique properties such as hardness, lubricating behavior, thermal conductivity, and electrical conductivity. The prediction and synthesis of various carbon allotropes have been a specific focus of materials researchers due to these fascinating features. Numerous unique carbon allotropes, including T carbon, Cco-C8, R carbon, Penta-C20, P carbon, Bct C4, etc., have been theoretically predicted in recent years. Among them, tetragonal body-centered carbon allotropes are the subject of extensive study due to their sp³ hybridized bonding character. Sp³ hybridized carbon is a tetravalent carbon that forms single covalent bonds (sigma bonds) with atoms of other p-block elements-Hydrogen, Oxygen, Carbon, Nitrogen, Halogens, and so forth. The bonds formed are of equal strength and at an angle of 109.5° due to which the central carbon atom is tetrahedral in shape. In physics and chemistry orbitals are a mathematical functions depicting the wave nature of an electron or a pair of electrons present in an atom. The probability of finding an electron around the nucleus can be calculated using this function. The term “sp³ hybridization” refers to the mixing character of one 2s-orbital and three 2p-orbitals to create four hybrid orbitals with similar characteristics. In order for an atom to be sp³ hybridized, it must have an s orbital and three p orbitals.

### BRIEF SUMMARY OF THE INVENTION

In an embodiment of the invention a process for synthesizing body-centered tetragonal carbon is provided, comprising securing a quantity of palm rachis material, thoroughly drying the rachis material, pre-carbonizing the dried rachis material, pulverizing the pre-carbonized and dried rachis material, and carbonizing the pulverized rachis material.

In one embodiment the rachis material is first sundried, then oven dried. Also, in one embodiment sun drying is accomplished for at least 48 hours. Also, in one embodiment the drying step comprises drying in an oven at a temperature of at least 110 degrees C. for at least 48 hours.

In one embodiment, in the pre-carbonizing step, the rachis material is heated at a temperature of at least 250 degrees C. for a period of two hours or more. Also, in one embodiment, in the pulverizing step, the rachis material is pulverized manually using a mortar and pestle. In one embodiment, in the pulverizing step, the rachis material is pulverized using a electrically powered apparatus. And in one embodiment, in the carbonizing step, the carbonization takes place in a muffle furnace under nitrogen flow at a temperature of at least 450 degrees C. for a period of more than two hours.

### BRIEF DESCRIPTION OF THE SEVERAL VIEWS OF THE DRAWINGS

FIG. 1A is an X-Ray Diffraction Pattern (XRD) of a biomass carbon in an embodiment of the present invention.

FIG. 1B illustrates the three-dimensional crystal structure of the carbon material in an embodiment of the invention.

FIG. 2A is an HRTEM image of the carbon structure in an embodiment of the invention.

FIG. 2B shows selected area electron diffraction (SAED) of the carbon material.

FIG. 3 illustrates the chemical structure of the tetragonal carbon sample analyzed using Raman spectroscopy over a spectral range of 4000-50 cm-1.

FIG. 4 illustrates x-ray photoelectron spectroscopy (XPS) analysis of BCT carbon in an embodiment of the invention.

FIG. 5 illustrates Differential Scanning calorimetry (DSC) analysis of synthesized BCT carbon in an embodiment of the invention.

FIG. 6 is a flow diagram illustrating a step-by-step method for synthesizing hybridized body-centered tetragonal (BCT carbon in an embodiment of the invention.

### DETAILED DESCRIPTION OF THE INVENTION

Carbon and allotropes of carbon are very widely studied areas due to fascinating properties. Many carbon allotropes and their properties have been predicted theoretically, but not experimentally synthesized. Body-centered tetragonal carbon is perhaps the most widely investigated theoretical carbon allotrope in the past decade due to excellent mechanical and thermal stability and superior electrical properties. But synthesis of this carbon phase has not been practically demonstrated till now. In this specification a method is provided for experimental synthesis of bct carbon from a bio precursor material, specifically coconut rachis.

Carbon can exist in different allotropic forms like graphite, diamond, fullerene and so on in nature. There are many theoretically predicted carbon allotropes, but most of the predicted forms are not experimentally synthesized.

Recently a carbon allotrope with tetragonal phase is getting more attention from researchers due to fascinating predicted properties. Theoretical studies revealed that a carbon allotrope with tetragonal phase may be highly stable and may have high mechanical stability at ambient conditions with a hardness of as much as 88 gigapascals (GPa), % which is more rigid than most carbon materials but less rigid than diamond. High thermal stability and excellent electronic properties were also predicted for these carbon materials. These materials may have widened applications in both electronic devices and the field of super hard materials.

In description below, details are presented for synthesis of a theoretically predicted body-centered tetragonal sp³ hybridized carbon from coconut rachis. The result is a highly crystalline carbon with tetragonal phase identified by x-ray diffraction analysis. The high-resolution transmission analysis and the d spacing calculated from selected area electron diffraction analysis also confirms the tetragonal structure of the synthesized carbon sample at an atomic scale. Higher intensity of the D band in Raman analysis indicates breakdown of sp² bonds which in turn means the presence of more sp³ bonds.

### Sample Preparation

To synthesize the tetragonal carbon structure, locally sourced coconut rachis was initially sun-dried for 48 hours, powdered, and oven-dried at 110° C. for 48 hours. The dried sample was pre-carbonized at a temperature of 250° C. for 2 hours, then pulverized using a mortar and pestle. A carbonization process was then performed in a laboratory muffle furnace under nitrogen flow at 450° C. for 2-3 hours.

### X-Ray Diffraction Analysis (XRD)

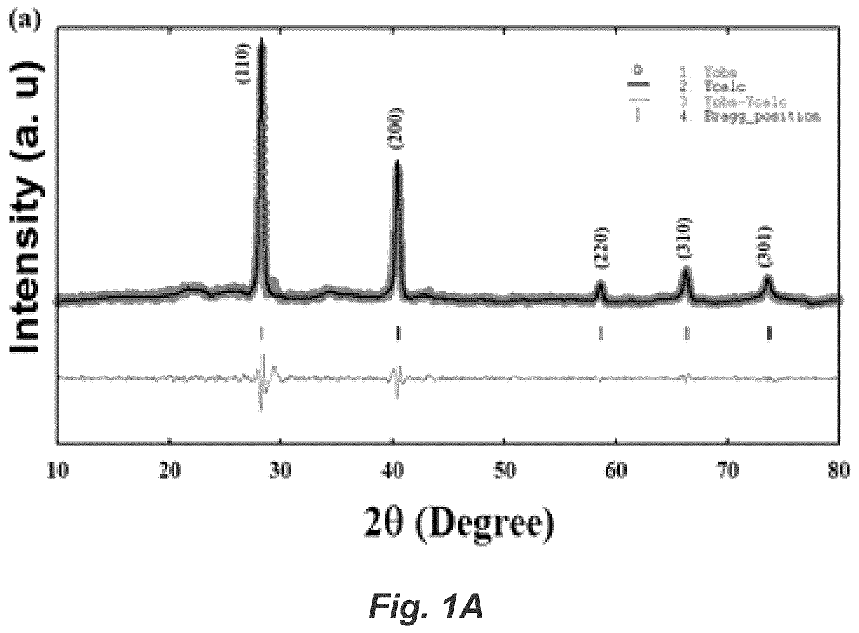

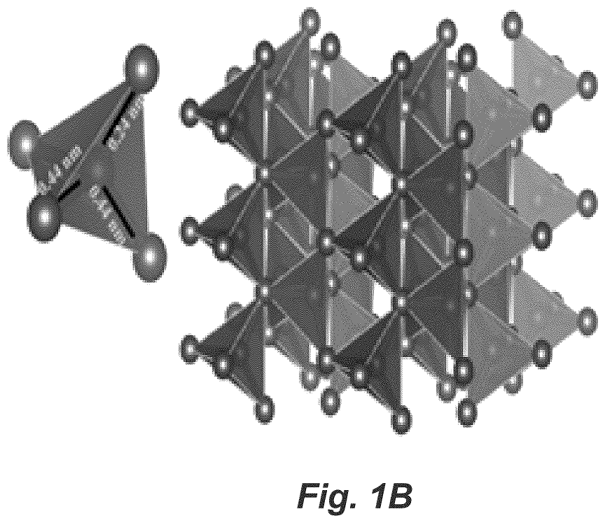

The crystal phase of the biomass carbon was analyzed using XRD as shown in FIG. 1A. The XRD pattern of the sample showed sharp and crystalline diffraction peaks at 2θ=28.65°, 40.73°, 58.83°, 66.65° and 73.86°, corresponding to (110), (200), (211), (310) and (301) planes, respectively, of the tetragonal phase of carbon (space group: 14/mmm [139]) (FIG. 1B). The lattice parameters “a” and “c” of carbon is calculated as 0.44 and 0.24 nm, respectively. The obtained values of lattice parameters are consistent with the standard reported data. The (110) diffraction peak is found to be predominant over all other diffraction peaks. The crystalline size of the graphite phase is calculated to be 23.04 nm using Debye Scherer's formula.

$$D = \frac{0.9 λ}{βcosθ} \qquad ( 1 )$$

where 2=1.54 Å is the wavelength of the X-ray (Cu-kα), θ is the Bragg diffraction angle and β is the Full Width at Half Maximum (FWHM) of the diffraction peak.

To further analyze the structural transition, Rietveld refinement of XRD patterns have been performed by the Fullprof Suite program. The pseudo-Voigt function was used for the refinement. An excellent match of peak positions was obtained from refinement including lattice and background parameters, instrument factors and R-factors and are listed in Table 1. Atomic positions parameters were held constant to the values provided by previous studies while the lattice parameters and profile parameters were refined. Residuals (R-values) from the refinement were calculated to be 31.4 for residual of least-squares refinement, R_{P}, 12.71 for weighted profile factor, Rexp, and 27.8 for weighted profile factor, Rwp. The Bragg factor (R_{Bragg}) and crystallographic factor (R_{f}) were obtained as 0.7516 and 1.957. The chi-square value (χ²) was obtained as 4.77. The low R-value of refinements and chi-square value indicates that the simulated parameters can fit with the experimentally acquired XRD pattern. The density of the synthesized sample was also observed after refinement, and a higher density value of 3.121 g/cm³ was obtained. This value is only 10.8% less than that of diamond, making the synthesized sample the only experimentally synthesized carbon allotrope after lonsdaleite whose density is closest to that of diamond.

TABLE 1
Rietveld refined structural parameters of carbon, simulated based on measured XRD patterns.

| | | | Atomic Positions | | | R factor | Bragg | |
|---|---|---|---|---|---|---|---|---|
| Sample | Cell Details | Atom | x | y | z | (%) | R-factor | RF-factor |
| C | a = 4.456 | C | 0.68028800 | 0.81971200 | 0.5000000 | Rp = 31.4 | 0.75160 | 1.957 |
| | b = 4.56 | C | 0.81971200 | 0.68028800 | 0.0000000 | Rwp = 27.8 | | |
| | c = 2.57 | C | 0.81971200 | 0.18028800 | 0.0000000 | Rexp = 12.7 | | |
| | α = β = ψ = 90° | C | 0.68028800 | 0.31971200 | 0.5000000 | x² = 12.7 | | |
| | | C | 0.18028800 | 0.18028800 | 0.0000000 | | | |
| | | C | 0.31971200 | 0.31971200 | 0.5000000 | | | |
| | | C | 0.31971200 | 0.68028800 | 0.5000000 | | | |
| | | C | 0.18028800 | 0.81971200 | 0.0000000 | | | |

### High Resolution Transmission Electron Microscopy (TEM) and Selected Area Electron Diffraction (HRTEM &SAED Analysis)

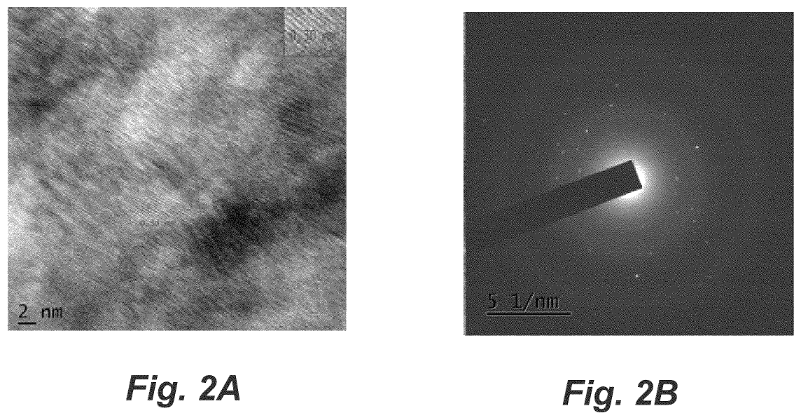

A high-resolution TEM image of the tetragonal carbon material is shown in FIG. 2A. The inset of FIG. 2A clearly shows the lattice fringes with an interplanar spacing of 0.30 nm, which is close to the (110) plane of synthesized tetragonal carbon material. FIG. 2B shows selected area electron diffraction (SAED) of the carbon material consisting of both spots and diffraction ring patterns, indicating the crystalline nature of the material. The diffraction patterns are consistent with tetragonal phase of carbon from XRD. The SAED indexed data is presented in Table 2. HRTEM imaging combined with SAED data analysis confirmed the tetragonal phase of the synthesized carbon on an atomic scale.

TABLE 2
d- Space calculation from SAED pattern of the synthesized sample

| | | | | d- | | | d-spacing |
|---|---|---|---|---|---|---|---|
| Sl. | 1/2r | 1/r | r | spacing | | XRD | from XRD |
| No: | (nm⁻¹) | (nm⁻¹) | (nm) | (A⁰) | (hkl) | peak | (A⁰) |
| 1 | 8.97 | 4.485 | 0.2296 | 2.296 | (200) | 40.734 | 2.213 |
| 2 | 12.661 | 6.3305 | 0.157 | 1.57 | (220) | 58.83 | 1.568 |
| 3 | 15.579 | 7.7895 | 0.1283 | 1.283 | (301) | 73.86 | 1.282 |
| 4 | 6.094 | 3.047 | 0.3281 | 3.281 | (110) | 28.659 | 3.112 |
| 5 | 13.636 | 6.818 | 0.1466 | 1.46 | (310) | 66.65 | 1.402 |

### Raman Analysis

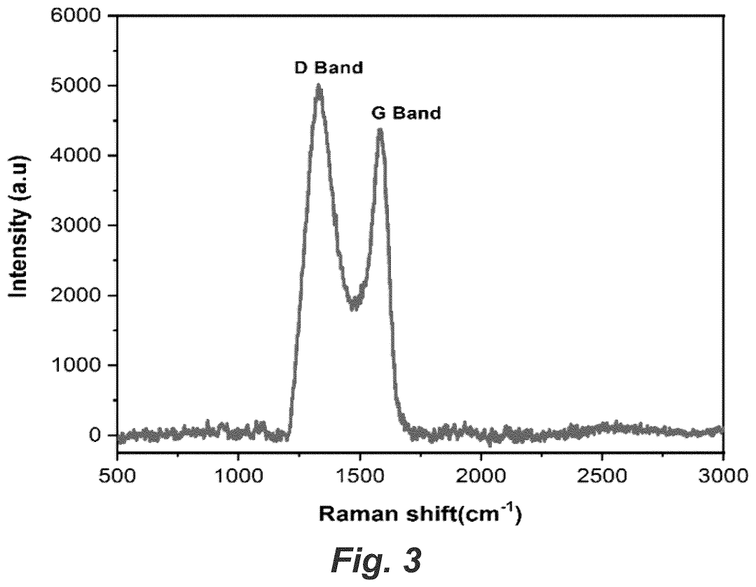

FIG. 3 illustrates the chemical structure of the tetragonal carbon sample analyzed using Raman spectroscopy over a spectral range of 4000-50 cm-1. In FIG. 2B, two distinctive absorption peaks may be observed at 1333 and 1582 cm-1, corresponding to the D-band and G-band, respectively. The D-band arises from the sp³-hybridization and defect state of the carbon atom, whereas the G-band originated from the in-plane vibration of the sp²-hybridized carbon. The higher Raman intensity for D-band indicates that a higher population of carbon atoms were sp³-hybridized, where the presence of sp²-hybridized carbon atoms cannot be neglected, considering the almost identical Raman intensity for the G-band peak.

### X-Ray Electron Spectroscopy (XPS)

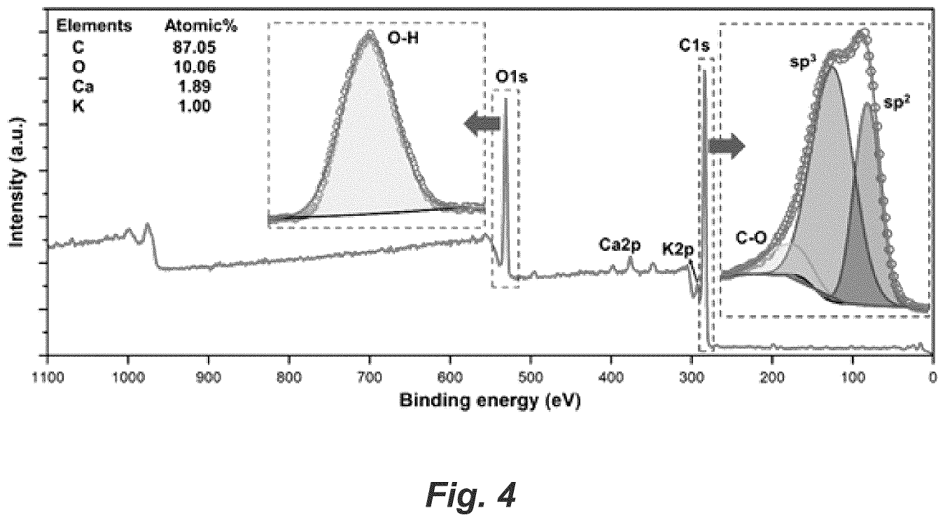

FIG. 4 shows XPS analysis similar to the Raman spectra. The survey XPS scan indicates that carbon and oxygen are the major constituents on the surface of the synthesized BCT carbon, with low concentrations of other metal elements (such as calcium and potassium). The occurrence of other elements at low concentrations was typical for biomass carbon. High-resolution spectra of both C1s and O1s (shown as inset in FIG. 4) were deconvoluted. The O1s spectrum shows only one peak at a binding energy of 531.4 eV, corresponding to the O—H bonding from adsorbed surface moisture.

Different from the O1s, the C1s spectrum may be deconvoluted into three individual peaks positioned at 282.8, 284.6, and 286.7 eV, corresponding to the sp², sp³, and oxidized states of the carbon atom, respectively. Comparing the area fraction of the deconvoluted peaks, the ratio between the sp², sp³, and oxidized carbon species may be determined as 32.5%, 58.8%, and 8.7%, respectively. Despite showing a higher concentration of sp³-hybridized carbon species, the XPS measurement indicated that sp²-hybridized species also exist on the surface of the synthesized BCT carbon. Correlating with the crystallography analyses, the data on chemical structure indicates that the synthesized BCT carbon has a body-centered tetragonal structure with high vacancy (defect) concentration. The vacancy could induce the formation of C═C(sp²-hybridization) when annealed under an inert atmosphere, explaining the presence of sp²-hybridized species in an sp³-dominated crystal structure.

### Differential Scanning Calorimetry (DSC)

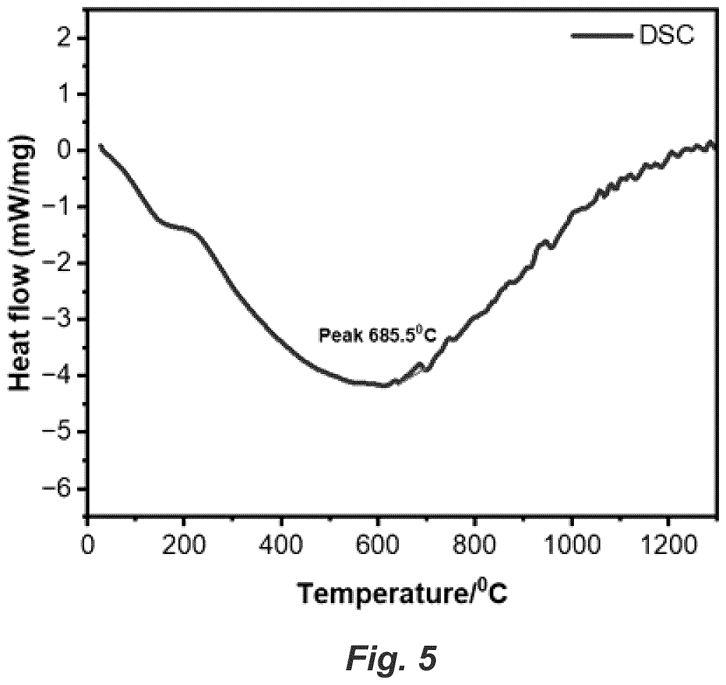

Temperature stability of the synthesized BCT carbon was analyzed using Differential Scanning calorimetry analysis in a temperature range from 0 to 1300° C., as shown in FIG. 5. The DSC curve shows a broad endothermic peak between 30° and 900° C. with a minimum of 600° C. during temperature treatment of the carbon sample. A small endothermic peak is observed at 685° C., indicating a phase transition.

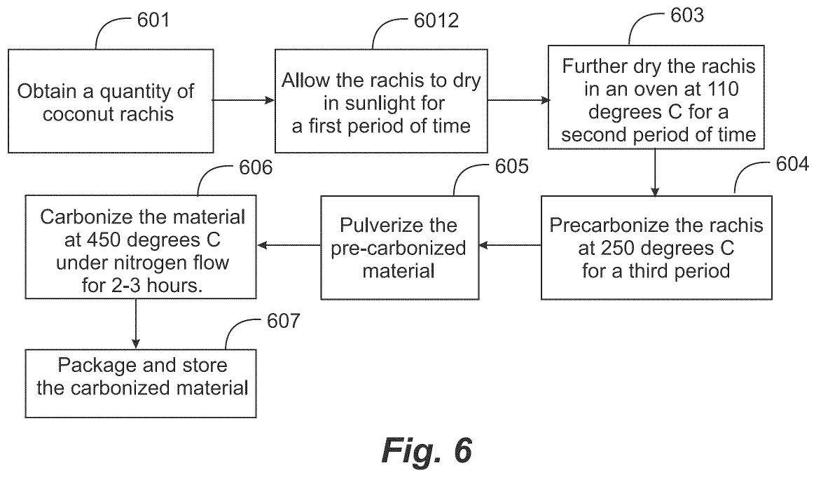

FIG. 6 is a flow diagram depicting a process of synthesizing BCT Carbon beginning with coconut rachis. The rachis of a coconut palm is essentially stems from which the leaves proceed, and is well-known in the art.

At step 601 a quantity of coconut rachis is procured. At step 602 the rachis is allowed to dry in sunlight for a first period of time. In one embodiment the sun drying proceeds for 48 hours or more (in sunlight). At step 603 the sun dried rachis may be powdered, and dried in an oven at or above 110 degrees C. for a second period of time. In one embodiment the second period may be 48 hours or more. At step 604 the oven dried material is pre-carbonized at about 250 degrees C. for a third period of time, which in one embodiment may be about 2 hours. At step 605 the pre-carbonized material is pulverized, which may in one embodiment be accomplished manually with a mortar and pestle, and in another embodiment may be accomplished with a powered apparatus. At step 606 the pulverized and pre-carbonized material is fully carbonized at 450 Degrees C. under a flow of nitrogen for a fourth period of time, which in one embodiment is about 2 to 3 hours. At step 607 the BCT carbon may be packaged and stored.

The nature of the fully carbonized material synthesized in this process is described in several places above with reference to figures showing results of tests determining that the material produced is hybridized, body-centered tetragonal carbon.

The skilled person will understand that the order of steps and the times and temperatures may vary somewhat in different embodiments. The skilled person will also understand that processes and descriptions in this specification are entirely exemplary, and are not limiting to the scope of the invention, which is limited only by the claims.

1. A process for synthesizing body-centered tetragonal carbon, comprising:
securing a quantity of palm rachis material;
thoroughly drying the rachis material;
pre-carbonizing the dried rachis material;
pulverizing the pre-carbonized and dried rachis material; and
carbonizing the pulverized rachis material.

2. The process of claim 1 wherein the rachis material is first sundried, then oven dried.

3. The process of claim 2 wherein sun drying is accomplished for at least 48 hours.

4. The process of claim 1 wherein the drying step comprises drying in an oven at a temperature of at least 110 degrees C. for at least 48 hours.

5. The process of claim 1 wherein, in the pre-carbonizing step, the rachis material is heated at a temperature of at least 250 degrees C. for a period of two hours or more.

6. The process of claim 1 wherein, in the pulverizing step, the rachis material is pulverized manually using a mortar and pestle.

7. The process of claim 1 wherein, in the pulverizing step, the rachis material is pulverized using a electrically powered apparatus.

8. The process of claim 1 wherein, in the carbonizing step, the carbonization takes place in a muffle furnace under nitrogen flow at a temperature of at least 450 degrees C. for a period of more than two hours.
